(19) United States
(12) Patent Application Publication
(10) Pub. No.: US 2009/0135066 A1
(43) Pub. Date: May 28, 2009

(54) Internal Monopole Antenna

(76) Inventors: Ari Raappana, Kello (FI); Marko Kupari, Kempele (FI); Anne Isohatala Lehmikangas, Kello (FI); Petteri Annamaa, Oulunsalo (FI); Jyrki Mikkola, Kaustinen (FI); Pasi Keskitalo, Oulu (FI); Sami Kyllonen, Helsinki (FI)

Correspondence Address: GAZDZINSKI & ASSOCIATES, 11440 WEST BERNARDO COURT, SUITE 375, SAN DIEGO, CA, 92127, US

(21) Appl. No.: 11/883,945

(22) PCT Filed: Jan. 11, 2006
(86) PCT No.: PCT/FI06/50017

§ 371 Date: Jun. 23, 2008

(30) Foreign Application Priority Data
Feb. 8, 2005 (FI) 20050146

(51) Int. Cl. H01Q 1/36; H01Q 1/48

(52) U.S. Cl. 343/700 MS; 343/846

(57) ABSTRACT

The invention relates in one aspect to antenna useful with for example a flat a radio device. In one embodiment, the antenna comprises and internal monopole antenna that has an arrangement for improving its characteristics, including a planar monopole radiator and an auxiliary element. The auxiliary element can be a mere conductor strip, or a ceramic plate partly coated with a conductor for example. The conductor of the auxiliary element is connected to the ground at a point (SP), which is relatively close to the feed point (FP) of the planar element. The planar element can be shaped to form two operating bands for the antenna. The auxiliary element can be used to increase the bandwidth of the internal monopole antenna and/or to improve the omnidirectional radiation of the antenna.

### PRIORITY AND RELATED APPLICATIONS

This application claims priority to PCT Application No. PCT/FI2006/050017 filed Jan. 11, 2006 of the same title, which claims priority to Finland Patent Application No. 20050146 filed Feb. 8, 2005 and entitled “Internal Monopole Antenna”, each of the foregoing being incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of Invention

The present invention relates to, inter alia, an internal monopole antenna such as may be used in a radio device. The exemplary monopole antenna has an arrangement for improving its characteristics, and is useful especially for small and flat radio devices with multiple operating bands.

2. Description of Related Technology

The internal antenna of small-sized portable radio devices, such as mobile phones, most often has a planar structure, which includes a radiating plane and a ground plane. In order to achieve sufficient electric characteristics, the minimum distance between these planes must be close to one centimeter or more. This leads into difficulties in the design of the antenna when the device is relatively flat, like the parts of a two-part communication device, in which the parts are either on top of each other or in succession one after the other, depending on the situation of use. For this reason, an antenna of the monopole type, which does not require as much space as the planar antenna mentioned above, is generally used in such communication devices.

FIG. 1 shows a typical internal monopole antenna of a device, known from Finland patent application publication FI 20022295, which is incorporated herein by reference in its entirety. A circuit board PCB of the radio device, the upper surface of which is mostly a conductive ground plane GND, is seen in the figure. At one end of the circuit board there is a small antenna circuit board 101 shaped like an elongated rectangle and supported to the circuit board PCB with one long side against it so that those circuit boards are at a right angle to each other. The radiating element of the antenna, i.e. the radiator, is a conductor strip 110 on the antenna circuit board, the feed point FP of which is at a lower corner of the antenna circuit board 101. From it, the conductor strip 110 runs on the lower edge of the antenna circuit board to its one end, then in the middle of the antenna circuit board back to the end on the side of the feed point and further on the upper edge of the antenna circuit board to its other end again. Thus the radiating element forms a meander pattern, which resembles a very wide and flat letter S. The edge of the ground plane GND is at a suitable distance from the radiator 110 in view of the matching of the antenna.

By using discrete tuning components, a harmonic of the basic resonance frequency of the antenna can be arranged so that two usable operating bands are obtained for the antenna. In addition, the upper operating band can be widened by dimensioning the slot between the portions of the conductor strip 110 so that an oscillation is excited in it, the frequency of which oscillation differs somewhat from the harmonic resonance frequency mentioned above. The structure saves space, and its antenna gain is higher than that of a PIFA (Planar Inverted F-Antenna) of the same height, for example.

However, the height of the antenna circuit board is a drawback in the case of very flat radio devices. In addition, the evenness of the directional pattern of the antenna leaves room for improvement.

In FIG. 2 there is another example of a known internal monopole antenna of a device. In this case, the radiator 210 of the antenna 200 is a conductor plate. The radiator is fastened to an end of the circuit board PCB of a radio device in a way that its planar surface is partly against the upper surface of the circuit board. There is continuous signal ground GND on the circuit board at a certain distance from the radiator 210. The feed conductor 205 of the antenna connects the radiator from the feed point FP to the antenna port on the lower surface of the circuit board PCB. The radiator includes a slot 215 starting from one edge thereof, which slot divides the radiator into two branches of different lengths as viewed from the feed point FP. For this reason the antenna 200 has two bands. The longer branch 211 of the radiator is dimensioned so that it radiates in the lower operating band of the antenna, and the shorter branch 212 is dimensioned so that it radiates in the upper operating band of the antenna. The result is an antenna that fits into a flat radio device operating, for example, in the frequency ranges used by the GSM900 system (Global System for Mobile telecommunications) and the GSM1800 or the GSM1900 system.

However, the bandwidths are relatively modest; the upper band, for example, cannot be made to cover the frequency ranges used by both the GSM1800 and the GSM1900 system. In addition, it is difficult to make the antenna gain satisfactory on the whole operating frequency range.

Based on the foregoing, there is a need of an improved antenna apparatus that has a very low profile; i.e., so that it can be used in very flat radio devices. Moreover, such improved antenna apparatus and methods would provide for a more even directional pattern of the antenna when used.

Additionally, such improved antenna apparatus would produce a greater bandwidth; e.g., such that the upper band would cover frequency band, such as the frequency ranges used by both the GSM1800 and the GSM1900 system, yet would have gain characteristics satisfactory over the entire operating frequency range.

### SUMMARY OF THE INVENTION

The present invention addresses the foregoing needs by disclosing apparatus and methods for an antenna.

In a first aspect of the invention, antenna apparatus is disclosed. In one embodiment, the apparatus comprises: a substantially planar main element in electrical communication with a first point; and an auxiliary element electrically coupled with a second point. A first distance from the substantially planar main element to the auxiliary element measured proximate the second point is substantially smaller than a second distance between the auxiliary element and main element measured away from the second point.

In one variant, the apparatus has a first and second end, and the first point and second point are disposed proximate one another at one of the first or second ends. The main elements are substantially parallel with one another for at least a majority of their surface areas. The auxiliary element is substantially co-extensive with the main element in one dimension.

In another variant, the main element and auxiliary element are each substantially elongated in shape and each have a first and a second end, and the first point and second point are disposed proximate one another on respective first ends of the main element and auxiliary element.

In yet another variant, the first distance being smaller than the second distance improves antenna matching in at least one operating band. The at least one operating band comprises and upper frequency band, and the improvement of matching is accomplished at least in part by strengthening a resonance of the auxiliary element.

In still another variant, the first point comprises a feed point (FP), and the second point comprises a short-circuit point (SP), the SP being in electrical communication with an electrical ground, and the auxiliary element is parasitic.

In yet a further variant, the antenna is configured for use in a low-profile radio frequency device such that an overall height of the antenna apparatus does not exceed 4 mm. The first and second points are disposed substantially on a circuit board of the radio frequency device.

In still another variant, the auxiliary element comprises a metal strip, and the substantially planar main element comprises a substantially “J” shaped channel formed therein.

In another variant, the electrical coupling of the auxiliary element and the second point comprises a capacitive coupling. The capacitive coupling permits the auxiliary element to have a reduced electric length over that required without the capacitive coupling.

In still a further variant, the main element comprises a first branch to form a lower operating band for the antenna and a second branch to form an upper operating band for the antenna, a majority of the auxiliary element being located proximate the second branch.

In another embodiment, the antenna apparatus comprises: a substantially planar main element having first and second portions, the first and second portions corresponding substantially to first and second radio frequency operating bands; and an auxiliary element disposed proximate the main element and adapted to enhance the uniformity of omni-directional radiation emitted from the apparatus.

In one variant, the enhanced uniformity occurs at least within the second band, the second band being higher in frequency than the first band.

In another variant, the auxiliary element functions as an auxiliary radiator based at least in part on its electric length. The electric length is selected so that a resonance frequency of the auxiliary element differs slightly from an upper resonance frequency of the main element.

In yet another variant, the main element is electrically coupled to a feed point, and the auxiliary element is electrically coupled to an electrical ground. The electrical coupling of the auxiliary element and the ground comprises a capacitive coupling (e.g., discrete capacitor). The auxiliary element and the main element are capacitively coupled as well.

In another variant, the auxiliary element and the main element are separated by a first distance at a first region of the main element, and by a second distance at a second region of the main element, the second distance being larger than the first distance. The first region is e.g., proximate the first and second points, and the second region is distal thereto.

In a second aspect of the invention, a method of operating an antenna is disclosed. In one embodiment, the method comprises: providing a first radiating element; providing a second radiating element in substantial proximity to but not in electrical contact with the first element; capacitively coupling the first and second elements; operating the first radiating element within at least a first frequency band, the first frequency band comprising at least one resonance frequency; and operating the second radiating element at a frequency which is proximate the at least one resonance frequency of the first element.

In one variant, the first and second elements are substantially planar, and providing a second element in substantial proximity to the first comprises providing the second element such that the first and second elements are disposed in a substantially parallel orientation and within 4 mm of each other, but not contacting one another.

In another variant, operating the first element within at least a first frequency band comprises operating so as to create first and second resonances, the first resonance corresponding to a first branch of the first element, and the second resonance corresponding to a second branch of the first element. Operating the second element at a frequency proximate the at least one resonance of the first element comprising operating the second element at a frequency proximate the second resonance of the first element.

In a third aspect of the invention, radio frequency apparatus is disclosed. In one embodiment, the apparatus comprises: a radio frequency transceiver; and an antenna apparatus in signal communication with the transceiver, and the antenna apparatus comprises: a substantially planar main element having first and second portions, the first and second portions corresponding substantially to first and second operating frequencies; and an auxiliary element disposed proximate the main element and parasitically coupled thereto, the auxiliary element adapted to radiate at a third operating frequency which is proximate, but not identical to, at least one of the first and second frequencies.

In one variant, the radio frequency apparatus comprises a substantially flat form factor, and the antenna apparatus comprises an overall height of no more than 4 mm.

In another variant, the first and second portions of the substantially planar main element cooperate to form a substantially “J” shaped channel within the main element.

In yet another variant, the substantially planar main element and the auxiliary element are disposed substantially parallel one another and in an over-under disposition, the main and auxiliary elements being separated by a first distance at a first end of the auxiliary element, and by a second distance at a second end of the auxiliary element, the first distance being smaller than the second distance.

In a fourth aspect of the invention, an internal monopole antenna of a radio device is disclosed. In one embodiment, the antenna comprises a main radiator of which antenna is a planar element and is connected to an antenna feed point (FP) on a circuit board (PCB) of the radio device. The antenna further comprises a parasitic auxiliary element, which is connected to a short-circuit point (SP) being located on the circuit board and belonging to a signal ground. The antenna is characterized in that the auxiliary element is located at the planar element as viewed in the direction of its normal and comprises a conductor, the distance of which from the planar element at the end of the auxiliary element on the side of the short-circuit point (SP) is substantially smaller than at the opposite end of the auxiliary element in order to improve the antenna matching.

In a fifth aspect of the invention, high-efficiency antenna apparatus for use in a radio frequency device is disclosed. In one embodiment, the apparatus comprises: a first substantially planar radiating element having first and second portions and first and second resonances associated therewith, respectively; a second substantially planar radiating element disposed substantially parallel to, and parasitically coupled to, the first element, and electrically coupled to a ground element. The efficiency of the antenna apparatus is enhanced due to at least the second element shielding between the first element and at least one other conductive parts of the radio frequency device

These and other aspects of the invention shall become apparent when considered in light of the disclosure provided herein.

### BRIEF DESCRIPTION OF THE DRAWINGS

In the following, the invention will be described in detail. Reference will be made to the accompanying drawings, in which:

FIG. 1 presents an example of a prior art internal monopole antenna of a radio device;

FIG. 2 shows another example of a prior art internal monopole antenna of a radio device;

FIG. 3 presents an example of an internal monopole antenna of a radio device according to the invention;

FIGS. 4a and 4b show the planar element and the auxiliary element of the antenna of FIG. 3, respectively;

FIGS. 5a-5c present another example of an internal monopole antenna of a radio device according to the invention;

FIG. 6 shows a variation of the antenna according to FIG. 3;

FIG. 7 presents a variation of the antenna according to FIGS. 5a-5c;

FIG. 8 shows an example of the effect of the invention on the directional characteristics of the antenna; and

FIG. 9 presents an example of the band characteristics of an antenna according to the invention.

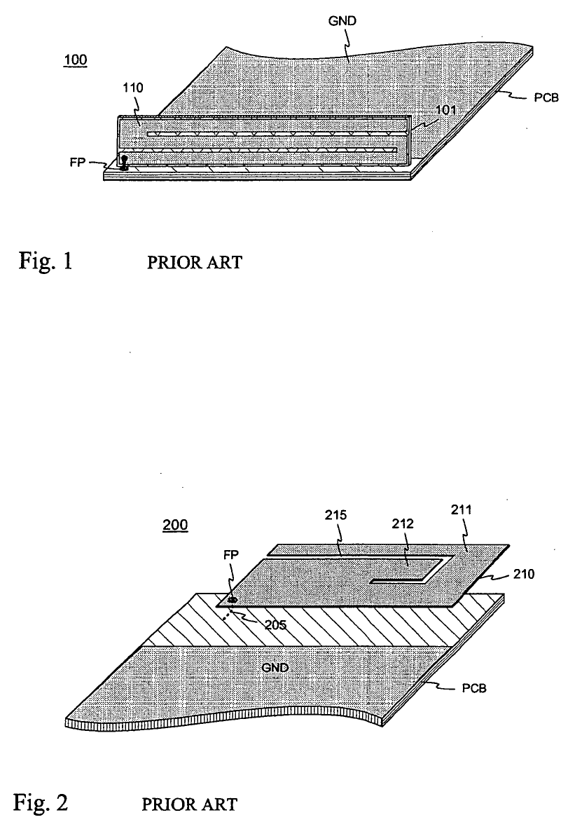

### DETAILED DESCRIPTION OF THE INVENTION

Reference is now made to the drawings wherein like numerals refer to like parts throughout.

As used herein, the terms “wireless”, “radio” and “radio frequency” refer without limitation to any wireless signal, data, communication, or other interface or radiating component including without limitation Wi-Fi, Bluetooth, 3G (3GPP/3GPPS), HSDPA/HSUPA, TDMA, CDMA (e.g., IS-95A, WCDMA, etc.), FHSS, DSSS, GSM, UMTS, PAN/802.15, WiMAX (802.16), 802.20, narrowband/FDMA, OFDM, PCS/DCS, analog cellular, CDPD, satellite systems, millimeter wave, or microwave systems.

### Overview

In one salient aspect of the invention, an improved internal antenna for use in e.g., a radio device is disclosed which comprises a planar element (e.g., monopole radiator), and an auxiliary element, which is located at the planar element (as viewed in the direction of its normal). The auxiliary element can be for example a mere conductor strip or a ceramic plate partly coated with conductor. The conductor of the auxiliary element is connected to the ground relatively close to the feed point of the planar element, and the distance of the conductor from the planar element at the grounded end is substantially smaller than at the opposite end. The planar element can advantageously be shaped to form two operating bands for the antenna.

The aforementioned apparatus has the advantage that the bandwidth of an internal monopole antenna can be increased by way of the auxiliary element. This ability is due to the fact that the auxiliary element can be dimensioned to function as an auxiliary radiator at a frequency which is close to e.g. the upper resonance frequency of the planar element functioning as the main radiator.

In addition, the apparatus has the advantage that the auxiliary element can be used to improve the omni-directional radiation of the antenna in the horizontal plane when the planar element of the antenna is vertical so that the ground plane of the radio device remains below it.

Yet a further advantage of the apparatus is that the efficiency of the internal monopole antenna, and thus the antenna gain, can be improved in at least part of the operating frequency range. This is due to the auxiliary element acting effectively as a shield between the main radiator and the other conductive parts of the radio device.

### DESCRIPTION OF EXEMPLARY EMBODIMENTS

Detailed discussions of various exemplary embodiments of the invention are now provided. It will be recognized that while described in terms of particular applications (e.g., mobile or radio devices including for example cellular telephones), materials, components, and operating parameters (e.g., frequency bands), the various aspects of the invention may be practiced with respect to literally any wireless or radio frequency application.

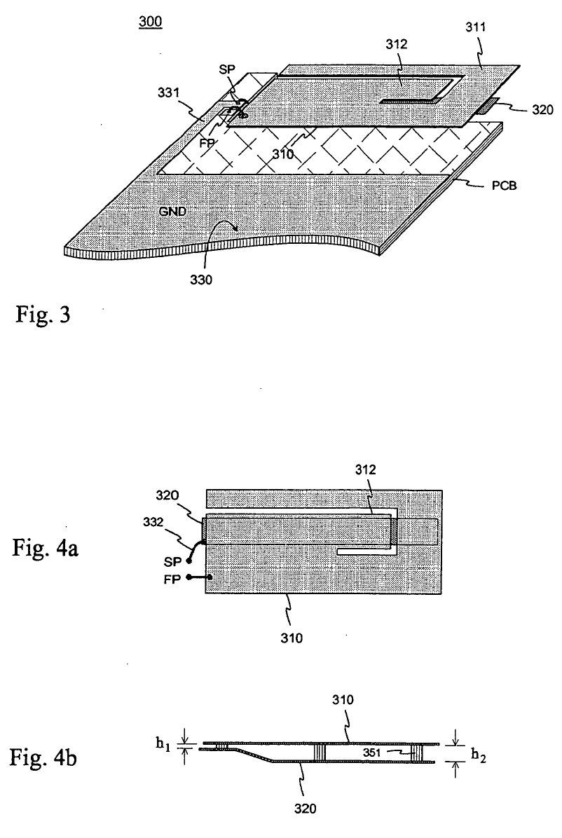

FIG. 3 presents an example of an internal monopole antenna of a radio device according to the invention. The main radiator 310 of the antenna 300 is a similar planar element at an end of the circuit board PCB of the radio device as the radiator 210 in FIG. 2. In the example, the long side of the planar element slightly overlaps the circuit board. It can also be outside the circuit board as seen from above. As viewed from its feed point FP, the planar element 310 has two branches of different lengths for forming two separate operating bands. The longer branch 311 runs along the edges of the planar element round the end of the shorter branch 312. On the circuit board PCB there is some conductive coating 330 functioning as the signal ground GND, or the ground in short, at a certain distance from the radiator 310. The antenna 300 also comprises an auxiliary element 320, which in this example is a metal strip being located under the planar element 310. The auxiliary element is parasitic in a way that it has only an electromagnetic coupling to the main radiator. The auxiliary element is connected to the ground at the short-circuit point SP, which is close to the feed point FP of the planar element and the whole antenna on the circuit board PCB. The short-circuit point SP joins to the larger signal ground 330 through its strip-like projection 331.

The planar element 310 and auxiliary element 320 of FIG. 3 are shown in FIGS. 4 a, b. In FIG. 4a they are seen from above, and in FIG. 4b from the side, when the circuit board of the radio device and the planar element of the antenna are assumed to be horizontal. Here the auxiliary element runs in the direction of the longer side of the rectangular planar element, has approximately the length of the planar element and is located at its shorter branch 312 as viewed from above, i.e. in the direction of the normal of the plane. In FIG. 4b it is seen that at the end on the side of the short-circuit point SP of the auxiliary element 320 its distance from the planar element 310 is smaller than at the opposite end of the auxiliary element. The former distance h₁ is 0.5 mm, for example, and the latter distance h₂ is 2 mm, for example. The total height of the antenna then remains under 3 mm, which means that the antenna fits well even into a very flat radio device. For this purpose, it is naturally advantageous to place the antenna essentially in the same geometrical plane as the circuit board PCB of the radio device. The auxiliary element is fastened to the planar element by dielectric support pieces, such as the support piece 351.

In this example, it is an object to improve the functioning of the antenna primarily in its upper operating band by means of the auxiliary element 320. From the effect of the auxiliary element, the omni-directional radiation of the antenna improves; i.e., its directional pattern becomes more even. An example of this is shown in FIGS. 7 and 8. In addition, if the electric length of the auxiliary element has been arranged suitably, it functions as a significant auxiliary radiator. The electric length is preferably arranged so that the resonance frequency of the auxiliary element differs slightly from the upper resonance frequency of the planar element, in which case the upper operating band of the antenna will be wider. With regard to the directional pattern, it is advantageous to make the auxiliary element physically as long as possible. If its length is then too long with regard to the band characteristics, the electric length can be reduced by arranging some capacitance between the auxiliary element and its short-circuit point SP by a discrete capacitor, for example. This would replace the short-circuit conductor 332 seen in FIG. 4a.

The above-mentioned matter that the distance h₁ is smaller than the distance h₂ improves the antenna matching in the upper operating band by strengthening the resonance of the auxiliary element. For the same reason, the conductor strips, on which the feed point FP and the short-circuit point SP are located, are at a close distance from each other. On the circuit board PCB this distance is less than one millimeter, for example. In this description and the claims, the qualifier “close distance” means a distance, the order of which is at the most one hundredth of the wavelength corresponding to the operating frequency.

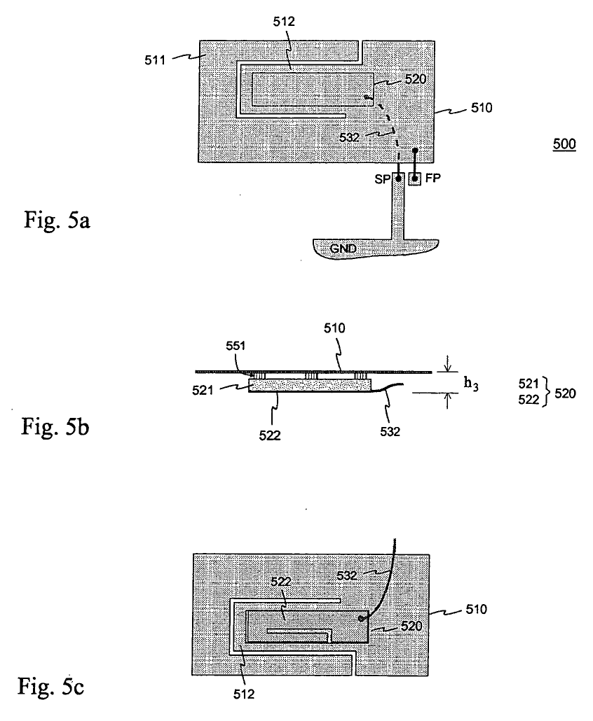

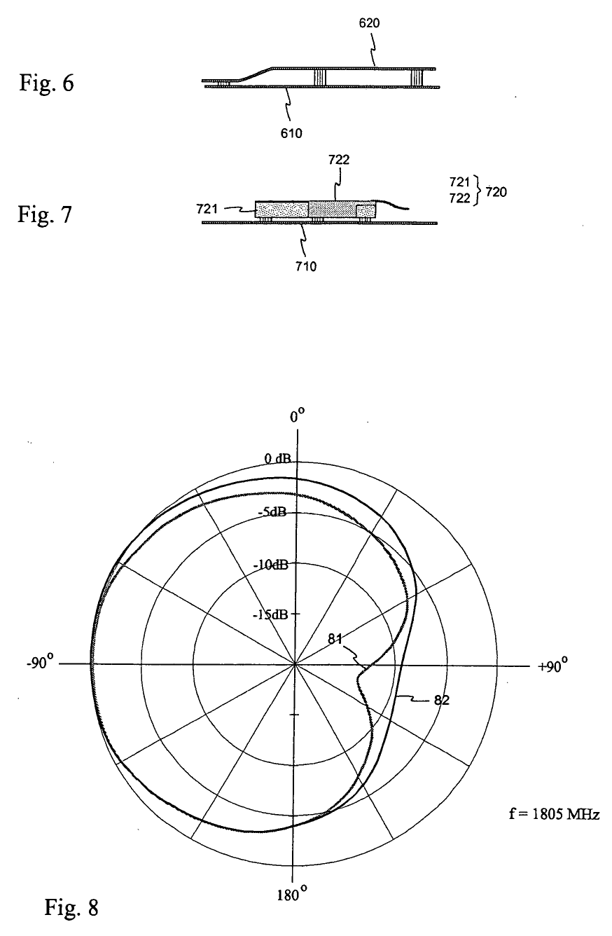

FIGS. 5a, 5b and 5c present another example of an internal monopole antenna of a radio device according to the invention. In FIG. 5a the structure is seen from above, in FIG. 5b from the side and in FIG. 5c from below, when it is assumed that the circuit board of the radio device and the planar element of the antenna are horizontal. The main radiator 510 of the antenna 500 is a similar planar element as the radiators shown in FIGS. 2 and 4a; only the radiating branches have been shaped slightly differently and the places of the feed and short-circuit points have been correspondingly chosen differently. The auxiliary element 520 belonging to the antenna 500 is located below the planar element 510 in this example, too. The auxiliary element comprises a ceramic plate 521 and a conductive coating 522 on its lower surface. The conductive coating is a parasitic element of the main radiator, and it is connected by a short-circuit conductor 532 to the ground at the short-circuit point SP, which is close to the feed point FP of the planar element and the whole antenna on the circuit board of the radio device. The auxiliary element 520 is located at the shorter branch 512 of the planar element as seen from above, or in the direction of the normal of the plane. FIG. 5b shows that the auxiliary element is fastened to the planar element and at the same time separated from it by support pieces, such as the support piece 551. The support pieces are of dielectric material, which has a lower permittivity than the ceramic 521. The distance between the auxiliary element and the planar element is 1 mm, for example, and the thickness of the auxiliary element 2 mm, for example. The total height of the antenna is then about 3 mm, which means that the antenna fits into a flat radio device in this case, too. For this purpose, it is advantageous to place the antenna of also this example essentially in the same geometrical plane as the circuit board of the radio device.

Also in this example, the object of the auxiliary element 520 is to improve the functioning of the antenna primarily in its upper operating band. The auxiliary element is dimensioned so that an oscillation is excited in the ceramic plate and it functions as an auxiliary radiator at a frequency which differs slightly from the upper resonance frequency of the planar element. The upper operating band of the antenna will then be wider. The ceramic resonator can be tuned by shaping its conductive coating 522. Therefore, a slot is seen in FIG. 4c in the conductive coating starting from its edge. In addition, the auxiliary element improves the antenna gain in the upper operating band in spite of the fact that the ceramic itself causes some losses. Namely, the auxiliary element reduces the coupling between the main radiator and the other conductive parts of the radio device, and thus losses in the parts not belonging to the antenna of the radio device.

In FIG. 6 there is a variation of the antenna according to FIG. 3. In FIG. 6, the antenna is seen from the side from the same direction as in FIG. 4b, i.e. as seen from the opposite end of the circuit board of the radio device. The auxiliary element 620 is now above the planar element 610 and not below it as in FIG. 4b.

In FIG. 7 there is a variation of the antenna according to FIGS. 5a, 5b, 5c. In FIG. 7, the antenna is seen from the side from the same direction as in FIG. 5b, i.e. as viewed from the opposite end of the circuit board of the radio device. The auxiliary element 720 is now above the planar element 710 and not below it as in FIG. 5b. In addition, the conductive coating 722 of the ceramic plate 721 belonging to the auxiliary element extends also to the lateral surface of the ceramic plate in this example.

In FIG. 8 there is an example of the effect of the invention on the directional characteristics of the antenna. The curves 81 and 82 present the horizontal directional pattern of the antenna, i.e. the antenna gain, as a function of the direction angle, when the circuit board PCB is in a vertical position. Curve 81 concerns a prior art antenna according to FIG. 2, and curve 82 an antenna according to FIG. 3, which comprises an auxiliary element according to the invention as an addition to FIG. 2. These antennas are designed for the 1.8 GHz range, among others, and the measurement frequency is 1805 MHz. It is seen that the gain of the known antenna is about −14 dB in the most adverse direction. On the other hand, the gain of a corresponding antenna according to the invention in the most adverse direction is about −9 dB, i.e. 5 dB higher. In addition, a gain that is higher by 1-2 dB is achieved in a range of about 180 degrees.

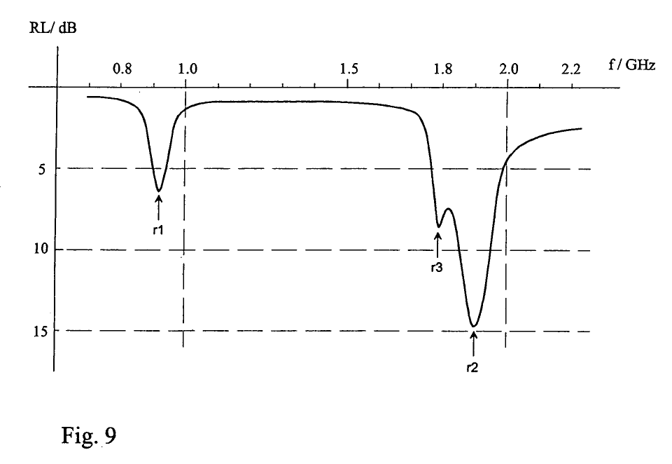

FIG. 9 shows an example of the band characteristics of an antenna according to the invention. The antenna is like the one shown in FIGS. 5a, 5b, 5c, in which the auxiliary element includes a ceramic plate in addition to the conductor. The figure shows a curve of the return loss RL as a function of frequency. It is seen from it that the antenna has three significant resonances. The first resonance r1 is based on the longer branch of the planar element of the antenna, and its frequency is about 920 MHz. The lower operating band of the antenna is formed by the first resonance. The second resonance r2 is based on the shorter branch of the planar element of the antenna, and its frequency is about 1.90 GHz. The third resonance r3 is based on the auxiliary element of the antenna, and its frequency is about 1.79 GHz. The upper operating band of the antenna is formed by the second and the third resonance. It is seen from the curve that by the effect of the auxiliary element the upper operating band is widened by about 50 MHz.

The qualifiers “lower” and “upper” as may be used in the specification and claims refer generally to the position of the radio device, in which the circuit board of the radio device and the planar element of the antenna are horizontal in a way that the feed and short-circuit point connected to the antenna are on the upper surface of the circuit board. The qualifiers have nothing to do with the position in which the devices are used. The antenna can be in any relative or absolute position when used.

A monopole antenna according to the invention has been described above. In its details, the implementation may differ from those presented. For example, the slot of the planar element of a dual band antenna can be shaped in a way that it functions as a significant radiator in the upper operating band. If the slot in that case does not form a clear conductor branch in the central area of the planar element, the auxiliary element according to the invention is essentially at the slot. In the description of the FIGS. 4b and 5b it was mentioned that the antenna fits into even a very flat radio device when it is placed on the same level with the circuit board of the device. This does not prevent from placing the antenna in such a way, for example, that its plane is at a right angle to the plane of the circuit board of the device, if such an arrangement is appropriate in some radio devices.

An antenna and methods of operating the antenna according to the invention have been described above. Their structural parts may differ in the details from those presented. For example, the shape and materials of construction of the antenna can vary greatly. Moreover, it will be appreciated that the multi-band arrangement of the main radiator described herein is not limited to two branches or bands, but may in fact have a greater number of branches/bands.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. Antenna apparatus, comprising:
a substantially planar main element in electrical communication with a first point; and
an auxiliary element electrically coupled with a second point;
wherein a first distance from the substantially planar main element to the auxiliary element measured proximate the second point is substantially smaller than a second distance between the auxiliary element and main element measured away from the second point.

2. The apparatus of claim 1, wherein the apparatus has a first and second end, and said first point and second point are disposed proximate one another at one of said first or second ends.

3. The apparatus of claim 2, wherein said main element are substantially parallel with one another for at least a majority of their surface areas.

4. The apparatus of claim 3, wherein said auxiliary element is substantially co-extensive with said main element in one dimension.

5. The apparatus of claim 1, wherein said main element and auxiliary element are each substantially elongated in shape and each have a first and a second end, and said first point and second point are disposed proximate one another on respective first ends of said main element and auxiliary element.

6. The apparatus of claim 1, wherein said first distance being smaller than the second distance improves antenna matching in at least one operating band.

7. The apparatus of claim 6, wherein said at least one operating band comprises and upper frequency band, and said improvement of matching is accomplished at least in part by strengthening a resonance of the auxiliary element.

8. The apparatus of claim 1, wherein said first point comprises a feed point (FP), and the second point comprises a short-circuit point (SP), said SP being in electrical communication with an electrical ground.

9. The apparatus of claim 8, wherein said auxiliary element is parasitic.

10. The apparatus of claim 1, wherein said antenna is configured for use in a low-profile radio frequency device such that an overall height of the antenna apparatus does not exceed 4 mm.

11. The apparatus of claim 10, wherein said first and second points are disposed substantially on a circuit board of the radio frequency device.

12. The apparatus of claim 1, wherein said substantially planar main element comprises a substantially “J” shaped channel formed therein.

13. The apparatus of claim 1, wherein said auxiliary element comprises a metal strip.

14. The apparatus of claim 1, wherein said auxiliary element comprises a ceramic plate and an electrically conductive layer disposed thereon.

15. The apparatus of claim 10, wherein said main element is located substantially in the same geometrical plane as the circuit board of the radio frequency device.

16. The apparatus of claim 1, wherein said electrical coupling of said auxiliary element and said second point comprises a capacitive coupling.

17. The apparatus of claim 16, wherein said capacitive coupling permits said auxiliary element to have a reduced electric length over that required without said capacitive coupling.

18. The apparatus of claim 1, wherein said main element comprises a first branch to form a lower operating band for the antenna and a second branch to form an upper operating band for the antenna, a majority of said auxiliary element being located proximate said second branch.

19. Antenna apparatus, comprising:
a substantially planar main element having first and second portions, said first and second portions corresponding substantially to first and second radio frequency operating bands; and
an auxiliary element disposed proximate said main element and adapted to enhance the uniformity of omni-directional radiation emitted from said apparatus.

20. The apparatus of claim 19, wherein said enhanced uniformity occurs at least within said second band, said second band being higher in frequency than said first band.

21. The apparatus of claim 19, wherein said auxiliary element functions as an auxiliary radiator based at least in part on its electric length.

22. The apparatus of claim 21, wherein said electric length is selected so that a resonance frequency of the auxiliary element differs slightly from an upper resonance frequency of the main element.

23. The apparatus of claim 19, wherein said main element is electrically coupled to a feed point, and said auxiliary element is electrically coupled to an electrical ground.

24. The apparatus of claim 23, wherein said electrical coupling of said auxiliary element and said ground comprises a capacitive coupling.

25. The apparatus of claim 24, wherein said auxiliary element and said main element are capacitively coupled only.

26. The apparatus of claim 23, wherein said auxiliary element and said main element are separated by a first distance at a first region of the main element, and by a second distance at a second region of the main element, said second distance being larger than said first distance.

27. The apparatus of claim 26, wherein said first region is proximate said first and second points, and said second region is distal thereto.

28. A method of operating an antenna, comprising:
providing a first radiating element;
providing a second radiating element in substantial proximity to but not in electrical contact with the first element;
capacitively coupling the first and second elements;
operating said first radiating element within at least a first frequency band, said first frequency band comprising at least one resonance frequency;
and operating said second radiating element at a frequency which is proximate the at least one resonance frequency of the first element.

29. The method of claim 28, wherein said first and second elements are substantially planar, and said providing a second element in substantial proximity to the first comprises providing said second element such that said first and second elements are disposed in a substantially parallel orientation and within 4 mm of each other, but not contacting one another.

30. The method of claim 28, wherein;
said operating said first element within at least a first frequency band comprises operating so as to create first and second resonances, said first resonance corresponding to a first branch of the first element, and the second resonance corresponding to a second branch of the first element; and
wherein said operating said second element at a frequency proximate the at least one resonance of the first element comprising operating the second element at a frequency proximate the second resonance of the first element.

31. Radio frequency apparatus, comprising:
a radio frequency transceiver; and
an antenna apparatus in signal communication with said transceiver, said antenna apparatus comprising:
a substantially planar main element having first and second portions, said first and second portions corresponding substantially to first and second operating frequencies; and
an auxiliary element disposed proximate said main element and parasitically coupled thereto, said auxiliary element adapted to radiate at a third operating frequency which is proximate, but not identical to, at least one of said first and second frequencies.

32. The radio frequency apparatus of claim 31, wherein said radio frequency apparatus comprises a substantially flat form factor, and said antenna apparatus comprises an overall height of no more than 4 mm.

33. The radio frequency apparatus of claim 31, wherein said first and second portions of said substantially planar main element cooperate to form a substantially “J” shaped channel within said main element.

34. The radio frequency apparatus of claim 31, wherein said substantially planar main element and said auxiliary element are disposed substantially parallel one another and in an over-under disposition, said main and auxiliary elements being separated by a first distance at a first end of said auxiliary element, and by a second distance at a second end of said auxiliary element, said first distance being smaller than said second distance.

35. An internal monopole antenna of a radio device, a main radiator of which antenna is a planar element and is connected to an antenna feed point (FP) on a circuit board (PCB) of the radio device, the antenna further comprising a parasitic auxiliary element, which is connected to a short-circuit point (SP) being located on the circuit board and belonging to a signal ground, characterized in that said auxiliary element is located at the planar element as viewed in the direction of its normal and comprises a conductor, the distance of which from the planar element at the end of the auxiliary element on the side of the short-circuit point (SP) is substantially smaller than at the opposite end of the auxiliary element in order to improve the antenna matching.

36. An antenna according to claim 35, characterized in that said conductor of the auxiliary element comprises a metal strip.

37. An antenna according to claim 35, characterized in that the auxiliary element further comprises a ceramic plate, and said conductor of the auxiliary element consists of a conductive coating of the ceramic piece.

38. An antenna according to claim 35, characterized in that said planar element is located substantially in the same geometrical plane as the circuit board (PCB) of the radio device.

39. An antenna according to claim 35, characterized in that the conductor strips of said circuit board (PCB), on which the feed point (FP) and the short-circuit point (SP) are located, are at a close distance from each other.

40. An antenna according to claim 36, characterized in that the auxiliary element is coupled capacitively to the short-circuit point to reduce the electric length of the auxiliary element.

41. An antenna according to claim 1, wherein the planar element comprises a first branch to form a lower operating band for the antenna and a second branch to form an upper operating band for the antenna, characterized in that the auxiliary element is located substantially at the second branch as viewed in the direction of the normal of the planar element.

42. An antenna according to claim 41, characterized in that the auxiliary element is located above the planar element.

43. An antenna according to claim 41, characterized in that the auxiliary element is located below the planar element.

44. An antenna according to claim 35, characterized in that the auxiliary element is separated from the planar element by dielectric support pieces.

45. An antenna according to claim 35, characterized in that its total height is less than 4 mm.

46. High-efficiency antenna apparatus for use in a radio frequency device, comprising:
a first substantially planar radiating element having first and second portions and first and second resonances associated therewith, respectively;
a second substantially planar radiating element disposed substantially parallel to, and parasitically coupled to, the first element, and electrically coupled to a ground element;
wherein the efficiency of the antenna apparatus is enhanced due to at least the second element shielding between the first element and at least one other conductive parts of the radio frequency device.
